(19) United States
(12) Patent Application Publication
(10) Pub. No.: US 2023/0374255 A1
(43) Pub. Date: Nov. 23, 2023

(54) POLYMER COMPOSITES COMPRISING CARBON SOURCE MATERIALS

(71) Applicant: Ohio University, Athens, OH (US)

(72) Inventors: Jason Patrick Trembly, Athens, OH (US); Vickram Dhanapal, Delaware, OH (US); Daniel Patrick Connell, South Park, PA (US)

(21) Appl. No.: 18/247,610

(22) PCT Filed: Jul. 7, 2022
(86) PCT No.: PCT/US2022/036345

§ 371 Date: Mar. 31, 2023

Related U.S. Application Data
(60) Provisional application No. 63/219,068, filed on Jul. 7, 2021.

(51) Int. Cl. C08K 3/04; C08K 3/36; C08K 3/22

(52) U.S. Cl. CPC C08K 3/04; C08K 3/36; C08K 3/22; C08K 2003/2227; C08K 2201/014; C08K 2201/003; C08K 2201/016; C08K 2201/005

(57) ABSTRACT

A carbon polymer composite (CPC) including a polymer and a carbon source material. The polymer may include polyvinyl chloride (PVC) and/or high density polyethylene (HDPE). The carbon source material may include coal and/or other sources of carbon. The carbon source material may be oxidized using a gaseous or liquid oxidizing agent. A CPC including PVC may be used to make a piping product. A CPC including HDPE may be used to make a wood replacement product.

### CROSS-REFERENCE TO RELATED APPLICATION

This application claims the benefit of the filing date of U.S. Patent Application Ser. No. 63/219,068, filed on Jul. 7, 2021, the disclosure of which is incorporated by reference herein in its entirety.

### STATEMENT OF FEDERALLY SPONSORED RESEARCH

This invention was made with government support under DE-FE0031809 awarded by U.S. Department of Energy. The government has certain rights in the invention.

### FIELD OF THE INVENTION

Exemplary embodiments of the present invention relate generally to polymer composites that comprise a carbon source material as a filler material.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

A common filler for a polymer composite is cellulosic material. Cellulosic materials, such as wood fiber, wood flour, sawdust, rice hulls, peanut shells, and the like, have long been added to thermoplastic compounds to achieve a wood-like composite providing reinforcement, reduced coefficient of expansion, and cost reduction.

Cellulosic filler has significant drawbacks. A major limitation of cellulosic fillers is the moisture sensitivity of cellulose fibers. This moisture sensitivity may require pre-drying of the cellulose fibers and the maintenance of low moisture conditions at the time of thermoplastic processing, particularly for cellulose in powder form. In addition, the moisture sensitivity of the cellulose fibers requires the exercise of special care during extrusion to ensure cellulosic encapsulation and/or protection against moisture absorption to avoid moisture deterioration of the cellulosic fibers. Furthermore, the extrusion process can cause thermal degradation of the cellulose fibers. Finally, although wood is a renewable resource, it takes many years for trees to mature. Consequently, the supply of wood for use as filler is decreasing and becoming more expensive as a result.

Inorganic fillers have therefore been used as an alternative or substitute for cellulosic fillers. Inorganic fillers such as talc, calcium carbonate, glass, kaolin clay, magnesium oxide, titanium dioxide, silica, mica, and barium sulfate have been used to eliminate or offset the moisture sensitivity and other drawbacks of cellulosic fillers. However, some known inorganic fillers may also pose processing difficulties or reduce mechanical properties of the composite. Some known inorganic fillers may also have limited availability, which may lead to increased costs.

Pulverized coal has also been proposed as a filler for certain polyolefin, polyamide, polypropylene, styrene, and/or thermoset composites. Such composites may lack in physical characteristics (e.g., strength, stiffness, impact resistance, UV resistance, etc.) for certain building, construction, infrastructure, transportation (e.g., automotive, airplanes, trucks, transportation structures, etc.), and furnishing applications.

A need also exists to reuse other carbon sources for filler that otherwise have limited or no alternative value. Such materials may frequently be destroyed in some costly manner, such as incineration. Alternatively, there may be an otherwise unproductive trip to a landfill.

In light of these shortcomings, there is a need for a polymer composite with improved moisture resistance characteristics. Another need exists for a polymer composite that is less susceptible to thermal degradation relative to traditional cellulosic-filled composites. A need also exists for a polymer composite that has improved physical and manufacturing characteristics such as, but not limited to, strength, stiffness, impact resistance, and extrudability. Yet another need exists to be able to use other materials as filler for polymer composite, wherein such materials otherwise have diminishing or no alternative value.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Exemplary embodiments of the present invention may satisfy some or all of the needs described above. One embodiment of the present invention is a carbon polymer composite (CPC) that includes a polymer that accounts for greater than or equal to 10 wt. % and less than or equal to 90 wt. % by weight of the CPC, and a carbon source material having a mesh size greater than or equal to 18M such that the carbon source material accounts for greater than or equal to 10 wt. % and less than or equal to 90 wt. % by weight of the CPC.

In one further embodiment, the mesh size of the carbon source material is greater than or equal to 120M. In an even further embodiment, the carbon source material has a second mesh size that is less than or equal to 500M. In another embodiment, the mesh size of the carbon source material is greater than or equal to 500M. In yet another embodiment, the mesh size of the carbon source material is greater than or equal to 4800M.

In one further embodiment, the carbon source material includes a plurality of particles each having a shape such that each particle has a minimum Feret diameter, a maximum Feret diameter, and an aspect ratio equal to the maximum Feret diameter divided by the minimum Feret diameter. In one such embodiment, the plurality of particles has an average aspect ratio greater than or equal to 1.0. In another such embodiment, the plurality of particles has an average aspect ratio greater than or equal to 2.5. In yet another such embodiment, the plurality of particles has an average aspect ratio greater than or equal to 4.0. In still another such embodiment, the plurality of particles has an average aspect ratio greater than or equal to 7.0.

In one further embodiment, the CPC further includes a lubricant package that accounts for greater than 0 wt. % and less than or equal to 8 wt. % by weight of the CPC.

In one further embodiment, the carbon source material includes a material selected from the group consisting of anthracite coal, semianthracite coal, bituminous coal, sub-bituminous coal, lignite, waste coal, carbon black, coke, coke breeze, carbon foam, carbon foam dust, petroleum coke, biochar, and charcoal. In an even further embodiment, the carbon containing material includes coal that has been thermally oxidized via treatment with a gaseous oxidant. In another even further embodiment, the carbon source material includes coal that has been oxidized via treatment with a liquid oxidizing agent.

In another further embodiment, the carbon source material includes a material selected from the group consisting of semi-anthracite coal, bituminous coal, and sub-bituminous coal. In one even further embodiment, the polymer includes polyvinyl chloride (i.e., PVC) and accounts for greater than or equal to 10 wt. % and less than or equal to 90 wt. % by weight of the CPC, and the carbon source material accounts for greater than or equal to 10 wt. % and less than or equal to 80 wt. % by weight of the CPC. In a still further embodiment of the invention, the carbon containing material is selected from the group consisting of Pittsburgh No. 8 coal, Keystone #325 coal, and Keystone #121 coal. In another still further embodiment of the invention, the CPC is used to make a piping product.

In another further embodiment where the carbon source material includes a material selected from the group consisting of semi-anthracite coal, bituminous coal, and sub-bituminous coal, the polymer includes high density polyethylene (i.e., HDPE) and accounts for greater than or equal to 19 wt. % and less than or equal to 60 wt. % by weight of the CPC, and wherein the carbon source material accounts for greater than or equal to 10 wt. % and less than or equal to 79 wt. % by weight of the CPC. In an even further embodiment, the CPC further includes a flame retardant that accounts for greater than or equal to 10 wt. % and less than or equal to 30 wt. % by weight of the CPC. In a still further embodiment, the flame retardant is selected from the group consisting of talc, aluminum trihydrate, and a mixture of talc and aluminum trihydrate.

In another further embodiment where the carbon source material includes a material selected from the group consisting of semi-anthracite coal, bituminous coal, and sub-bituminous coal, the CPC is used to make a wood replacement product.

In another further embodiment, the CPC further includes an additive selected from the group consisting of a lubricant, a stabilizer, an impact modifier, a high heat modifier, a coupling agent, a UV resistance modifier, and a foaming agent.

In addition to the novel features and advantages mentioned above, other benefits will be readily apparent from the following descriptions of exemplary embodiments.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention. Similar reference numerals are used to indicate similar features throughout the various figures of the drawings.

FIG. 1A shows a graph comparing flexural strengths and flexural moduli of HDPE-based carbon plastic composites (i.e., CPCs) including 120M mesh size Pittsburgh No. 8 (P8) coal filler at 40 wt. %, 50 wt. %, 60 wt. %, and 70 wt. % having a mesh size of 120M to various wood plastic composites (i.e., WPCs).

FIG. 1B shows a graph comparing flexural strengths and flexural moduli of HDPE-based CPCs including 120M mesh size Powder River Basin (PRB) coal filler at 40 wt. %, 50 wt. %, 60 wt. %, and 70 wt. % having a mesh size of 120M to various WPCs.

FIG. 1C shows a graph comparing flexural strengths and flexural moduli of HDPE-based CPCs including 325M mesh size Omnis reclaimed coal (Omnis) coal filler at 50 wt. % untreated, 50 wt. % treated, 70 wt. % untreated, and 70 wt. % treated having a mesh size of 325M to the various WPCs.

FIG. 1D shows a graph comparing flexural strengths and flexural moduli of HDPE-based CPCs including 50 wt. % P8 coal filler at various mesh sizes to HDPE-based CPCs containing 70 wt. % P8 coal filler at various mesh sizes.

FIG. 2A shows a graph comparing tensile strengths of PVC-based CPCs including 10 wt. %, 20 wt. %, 25 wt. %, and 30 wt. % of P8 coal filler having a mesh size of 120M to a masterbatch and piping blend.

FIG. 2B shows a graph comparing tensile strengths of PVC-based CPCs including 10 wt. %, 20 wt. %, 25 wt. %, and 30 wt. % of P8 coal filler having a mesh size of 325-500M to a masterbatch and piping blend.

FIG. 2C shows a graph comparing tensile strengths of PVC-based CPCs including 10 wt. %, 20 wt. %, 25 wt. %, and 30 wt. % of P8 coal filler having a mesh size of 500M to a masterbatch and piping blend.

FIG. 2D shows a graph comparing tensile strengths of PVC-based CPCs including 10 wt. %, 20 wt. %, 25 wt. %, and 30 wt. % of Keystone #325 coal filler having a mesh size of 325M to a masterbatch and piping blend.

FIG. 2E shows a graph comparing tensile strengths of PVC-based CPCs including 10 wt. %, 20 wt. %, 25 wt. %, and 30 wt. % of Keystone #121 coal filler having a mesh size of 325M (90 wt. %) to a masterbatch and piping blend.

FIG. 3A shows a graph comparing moduli of elasticity of PVC-based CPCs including 10 wt. %, 20 wt. %, 25 wt. %, and 30 wt. % of P8 coal filler having a mesh size of 120M to a masterbatch and piping blend.

FIG. 3B shows a graph comparing moduli of elasticity of PVC-based CPCs including 10 wt. %, 20 wt. %, 25 wt. %, and 30 wt. % of P8 coal filler having a mesh size of 325-500M to a masterbatch and piping blend.

FIG. 3C shows a graph comparing moduli of elasticity of PVC-based CPCs including 10 wt. %, 20 wt. %, 25 wt. %, and 30 wt. % of P8 coal filler having a mesh size of 500M to a masterbatch and piping blend.

FIG. 3D shows a graph comparing moduli of elasticity of PVC-based CPCs including 10 wt. %, 20 wt. %, 25 wt. %, and 30 wt. % of Keystone #325 coal filler having a mesh size of 325M to a masterbatch and piping blend.

FIG. 3E shows a graph comparing moduli of elasticity of PVC-based CPCs including 10 wt. %, 20 wt. %, 25 wt. %, and 30 wt. % of Keystone #121 coal filler having a mesh size of 325M (90 wt. %) to a masterbatch and piping blend.

FIG. 4A shows a graph comparing impact resistances of PVC-based CPCs including 10 wt. %, 20 wt. %, 25 wt. %, and 30 wt. % of P8 coal filler having a mesh size of 120M to a masterbatch and piping blend.

FIG. 4B shows a graph comparing impact resistances of PVC-based CPCs including 10 wt. %, 20 wt. %, 25 wt. %, and 30 wt. % of P8 coal filler having a mesh size of 325-500M to a masterbatch and piping blend.

FIG. 4C shows a graph comparing impact resistances of PVC-based CPCs including 10 wt. %, 20 wt. %, 25 wt. %, and 30 wt. % of P8 coal filler having a mesh size of 500M to a masterbatch and piping blend.

FIG. 4D shows a graph comparing impact resistances of PVC-based CPCs including 10 wt. %, 20 wt. %, 25 wt. %, and 30 wt. % of Keystone #325 coal filler having a mesh size of 325M to a masterbatch and piping blend.

FIG. 4E shows a graph comparing impact resistances of PVC-based CPCs including 10 wt. %, 20 wt. %, 25 wt. %, and 30 wt. % of Keystone #121 coal filler having a mesh size of 325M (90 wt. %) to a masterbatch and piping blend.

FIG. 5A shows a graph comparing total heat release amounts for HDPE-based CPCs including 40 wt. %, 50 wt. %, 60 wt. %, and 70 wt. % P8 coal filler, some of which include flame retardants, to various WPCs.

FIG. 5B shows a graph comparing peak heat release rates (peak HRR) for HDPE-based CPCs including 40 wt. %, 50 wt. %, 60 wt. %, and 70 wt. % P8 coal filler, some of which include flame retardants, to various WPCs.

FIG. 5C shows a graph comparing total smoke release amounts for HDPE-based CPCs including 40 wt. %, 50 wt. %, 60 wt. %, and 70 wt. % P8 coal filler, some of which include flame retardants, to various WPCs.

FIG. 6A shows a graph comparing total heat release amounts for HDPE-based CPCs including 40 wt. %, 50 wt. %, 60 wt. %, and 70 wt. % P8 coal filler to various WPCs.

FIG. 6B shows a graph comparing peak heat release rates for HDPE-based CPCs including 40 wt. %, 50 wt. %, 60 wt. %, and 70 wt. % P8 coal filler to various WPCs.

FIG. 6C shows a graph comparing total smoke release amounts for HDPE-based CPCs including 40 wt. %, 50 wt. %, 60 wt. %, and 70 wt. % P8 coal filler to various WPCs.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Exemplary embodiments of the present invention are directed to polymer composites comprising carbon source material, also referred to herein as carbon polymer composites or carbon plastic composites (i.e., CPCs). Related components and manufacturing methods are also included. Relative to the known art, exemplary embodiments may include CPCs having improved or similar physical characteristics such as strength, stiffness, impact resistance, extrudability, resistance to thermal degradation, resistance to moisture, resistance to mold, resistance to mildew, and/or resistance to flammability. Relative to the known art, exemplary embodiments may also satisfy the need for the use of different carbon sources, carbon chains, and/or carbon sizes.

One exemplary embodiment is a CPC comprising PVC. Compared to high density polyethylene (i.e., HDPE), the use of PVC may result in a CPC having higher strength, stiffness, and/or impact resistance. Furthermore, in some exemplary embodiments, PVC may be co-extruded or otherwise mixed with another amorphous material such as, for example, acrylonitrile butadiene styrene (i.e., ABS), polycarbonate, polymethyl methacrylate (PMMA), cyclic olefin copolymer (COC), acrylic, acrylonitrile styrene acrylate (ASA), polystyrene, other similar amorphous materials, or combinations thereof. PVC may also be combined with UV-resistant amorphous polymers such as, for example, acrylic, acrylonitrile styrene acrylate (i.e., ASA), or other similar or suitable amorphous polymers to improve UV fade resistance. In one exemplary embodiment, PVC (or PVC in combination with another amorphous polymer) is included in a CPC in amount of about 10 wt. % to about 90 wt. %, more preferably between 30 wt. % to about 90 wt. %, or even more preferably in an amount of about 69 wt. % to about 90 wt. %. In a further embodiment, the CPC may contain approximately 69-70 wt. % PVC. In another further embodiment, the CPC may contain approximately 74-75 wt. % PVC. In yet another further embodiment, the CPC may contain approximately 79-80 wt. % PVC. In another further embodiment, the CPC may contain approximately 89-90 wt. % PVC.

However, as set forth herein, some exemplary embodiments may not implement PVC. In some exemplary embodiments, the CPC may include HDPE instead. Furthermore, in some exemplary embodiments, HDPE may be co-extruded or otherwise mixed with another crystalline material such as, for example, polypropylene, other similar amorphous materials, or combinations thereof. In one exemplary embodiment, HDPE (or HDPE in combination with another crystalline polymer) is included in a CPC in amount of about 10 wt. % to about 90 wt. %, or more preferably in an amount of about 19 wt. % to about 60 wt. %. In a further embodiment, the CPC may contain approximately 29-30 wt. % HDPE. In another further embodiment, the CPC may contain approximately 39-40 wt. % HDPE. In yet another further embodiment, the CPC may contain approximately 49-50 wt. % HDPE. In another further embodiment, the CPC may contain approximately 59-60 wt. % HDPE.

Alternative embodiments may use thermoset resins as well, such as, for example, polyesters, epoxy, phenolic, polyurethane, polyamides, and/or vinyl esters.

In another exemplary embodiment, a CPC comprises at least one carbon source material in an amount up to about 70% by weight, or more preferably between 10 wt. % and 70 wt. % by weight of the CPC. The amount of carbon source material used in the CPC may vary based on the type of polymer. In one further embodiment, the amount of carbon source material used in an HDPE-based CPC may be greater than or equal to 10 wt. % and less than or equal to 79 wt. %, and more preferably greater than or equal to 40 wt. % and less than or equal to 70 wt. % by weight of the CPC. For example, the amount of carbon source material in an HDPE-based CPC may be approximately 40 wt. %, approximately 50 wt. %, approximately 60 wt. %, or approximately 70 wt. % by weight of the CPC depending on the embodiment. In another further embodiment, the amount of carbon source material in a PVC-based CPC may be greater than or equal to 10 wt. % and less than or equal to 90 wt. %, and more preferably greater than or equal to 10 wt. % and less than or equal to 30 wt. % by weight of the CPC. For example, the amount of carbon source material in a PVC-based CPC may be approximately 10 wt. %, approximately 20 wt. %, approximately 25 wt. %, or approximately 30 wt. % by weight of the CPC depending on the embodiment.

The carbon source material itself can be (1) a material or materials that are carbon-based alone, or (2) a mix of the material/materials that are carbon-based with other non-carbon based materials (those other non-carbon based materials excluding the polymer of the composite). In other words, the polymer composite of the present invention generally includes (1) a polymer, and (2) a carbon source material. That carbon source material can include the carbon-based material alone, or a mix of carbon and non-carbon materials (those non-carbon materials not including the polymer itself). In exemplary embodiments where carbon source material is a mix of carbon-based and non-carbon-based materials, the carbon-based material may account for about 1 to 90% by weight of the mixed carbon source material. In certain embodiments, at least one carbon-based material may be selected from the group consisting of anthracite coal, semi-anthracite coal (e.g., Keystone #121), bituminous coal (e.g., Pittsburgh No. 8, Omnis Reclaimed Coal, Keystone #325, and Itman), sub-bituminous coal (e.g., Powder River Basin), lignite, waste coal, carbon black, coke, coke breeze, carbon foam, carbon foam dust, petroleum coke, biochar, charcoal, and mixtures of these. In another exemplary embodiment, at least one carbon source material may be selected from the group consisting of waste coal, carbon black, coke, coke breeze, carbon foam, carbon foam dust, petroleum coke, biochar, charcoal, and mixtures of these. Examples of coke (e.g., petroleum coke) and coke breeze may be industrial byproducts that are predominantly carbon. Those of ordinary skill in the art, however, will recognize that “coke” may refer to substances other than petroleum coke; coke could refer to coal-derived coke, such as metallurgical coke, foundry coke, an industrial product (such as metallurgical coke), or a byproduct (such as coke breeze). An example of waste coal may comprise coal and optionally inorganic materials (e.g., soil). Further examples of waste coal may include the following: fine coal refuse such as, for example, waste coal slurry, tailings, or settling pond material; coarse coal refuse or hollow fill material; intermediate prep plant streams or middlings; fly ash with intermixed carbon (loss on ignition); and refined carbon materials derived from the above waste streams. Examples of biochar may be derived from woody biomass, non-woody biomass, animal/human waste, and algae.

Exemplary embodiments may also include different sizes of carbon source material. The sizes of the carbon source material may be determined or selected by using mesh (i.e., sieve) separation technique. When using a mesh or sieve to separate particles out by size, the mesh size given in units M indicates the number of openings per square inch of mesh. Accordingly, the higher the mesh size number, the smaller the opening and the smaller the particles must be in order to be able to pass through said opening. For example, a 120M mesh size has openings of 125 μm, a 200M mesh size has openings of 74 μm, a 325M mesh size has openings of 44 μm, and a 500M mesh size has openings of 25 μm. In some embodiments, a single mesh is used to select a maximum particle size. For example, a 120M mesh may be used to select particles having a size less than or equal to 125 μm. In other embodiments, a plurality of meshes are used to select a range of particle sizes. For example, particles may first be subjected to a 120M mesh and subsequently subjected to a 200M mesh, as may be indicated by a mesh size number of 120-200M. In such an embodiment, the particles having a size greater than 74 μm and less than or equal to 125 μm are able to pass through the 120M mesh but not the 200M mesh.

In exemplary embodiments, the carbon source material may include particles that have at least one dimension less than or equal to 1,000 μm (i.e., 18M), more preferably less than or equal to 500 μm (i.e., 35M), and more preferably less than or equal to 125 μm (i.e., 125M). In a further embodiment, the carbon source material may include particles that have at least one dimension less than or equal to 74 μm (i.e., 200M). In another further embodiment, the carbon source material may include particles that have at least one dimension less than or equal to 44 μm (i.e., 325M). In yet another further embodiment, the carbon source material may include particles that have at least one dimension less than or equal to 25 μm (i.e., 500M). In yet another further embodiment, the carbon source material may include particles that have at least one dimension less than or equal to 2 μm (i.e., 4800M). In other exemplary embodiments, the carbon source material may include particles that have at least one dimension greater than 25 μm and less than or equal to 1000 μm (i.e., 18-500M), more preferably greater than 25 μm and less than or equal to 500 μm (i.e., 35-500M), and more preferably greater than 25 μm and less than or equal to 125 μm (i.e., 120-500M). In a further embodiment, the carbon source material may include particles that have at least one dimension greater than 74 μm and less than or equal to 125 μm (i.e., 120-200M). In another further embodiment, the carbon source material may include particles that have at least one dimension greater than 44 μm and less than or equal to 74 μm (i.e., 200-325M). In yet another further embodiment, the carbon source material may include particles that have at least one dimension greater than 25 μm and less than or equal to 44 μm (i.e., 325-500M).

The carbon source material may include particles each having a shape such that each particle has a minimum Feret diameter and a maximum Feret diameter. The minimum Feret diameter is equal to the minimum distance between two lines which are both tangential to the particle and parallel to each other. The maximum Feret diameter is equal to the greatest distance between two parallel lines which are both tangential to the particle and parallel to each other. The aspect ratio of these particles can be expressed by dividing the maximum Feret diameter by the minimum Feret diameter. In exemplary embodiments, the carbon source material will include particles having an average aspect ratio greater than or equal to 1.0, more preferably greater than or equal to 2.5, and more preferably greater than or equal to 4.0, and even more preferably greater than or equal to 7.0.

Different types of carbon source materials may have different ranges of particle sizes. For example, a carbon source material such as, for example, coal dust may have an average maximum diameter between 1-18 μm, which may include carbon dust. Moreover, the carbon source material may be processed prior to incorporation in a CPC. In particular embodiments, coal may be ground to a particle size of about 5 μm to about 300 μm, generally about 25-50 μm. Generally, the CPC includes a carbon source material in an amount up to about 90 wt. % by weight of the CPC. In another embodiment, the CPC includes a carbon source material in an amount up to about 40 wt. % to about 70 wt. % by weight of the CPC.

Exemplary embodiments may also implement various types of coal chemistry. For example, since the carbon source material is not meant to be burned, carbon source material may comprise any level of volatile matter, sulfur, ash, minerals, impurities, hardness (e.g., Hardgrove Grindability Index), etc., which may facilitate the use of materials that otherwise have little or no alternative value. In exemplary embodiments, the type of carbon source material may take into account the desired mechanical properties, fire resistance, oxidation resistance, etc. of the end composite material.

Furthermore, the composites of the various embodiments of the present invention may include oxidized coal or coal that has been oxidized via contact with air, oxygen, alternative gaseous oxidizing agent, or mixtures thereof. Coal may be oxidized at temperatures up to 350° C. introducing and/or increasing oxygen functionality (e.g., R*, ROOH, RO*) of the coal's surface. Ideally, coal is contacted with a gaseous oxidizer preferably less than 200 hours, more preferably less than 24 hours, even more preferably less than 1 min. During compounding of the composite, oxygen functionalities react with thermoplastic resin, causing enhanced bonding between the oxidized coal surface and plastic resulting in a stronger material. Alternatively, liquid oxidizing agents via treatment with acid, hydrogen peroxide, other liquid oxidizers, or mixtures thereof may be used to oxidize the surface of coal before compounding with plastic resins.

In addition to the polymer and coal, a coupling agent or compatibilizing agent can also be employed. A coupling agent forms a bridge between the polymer chains and the surface of the fillers. Typically, the carbon chain of the coupling agent interacts with the thermoplastic matrix while the functional part interacts chemically with the surface functionalities of the filler. When load is applied on the plastic composite, it is transferred from the polymer matrix to the reinforcement phase via the coupling agent bond. Various suitable compatibilizing agents are disclosed in U.S. Pat. No. 8,901,209, which is incorporated herein by reference. Hydrophilic group grafted polyolefins can be used. One particular compatibilizing agent is maleic anhydride grafted polyethylene (MAPE), although agents such as maleic anhydride modified polypropylene (MAPP) or wax can also be used. Other coupling agents well known in the industry can also be used in the present invention. Generally, the coupling agent will be present in about an amount of 0 wt. % to 7 wt. %, generally from 0.05 wt. % to 3 wt. % and, in certain situations, 0.05 wt. % to 1.0 wt. % by weight of the CPC.

Various other fillers may also be used in addition to the carbon source materials. In some exemplary embodiments, additional fillers may be included in an amount of up to about 30 wt. %, more preferably about 10-30 wt. % by weight of the CPC. Some examples may include even more additional fillers. Examples of additional fillers may be selected from the group consisting of organic fillers (e.g., wood sawdust), inorganic fillers (e.g., talc and/or alumina trihydrate), and mixtures thereof (e.g., organic plus another organic; organic plus inorganic material; or organic plus another organic plus inorganic). In an exemplary embodiment, the fillers may be selected depending upon product needs.

Exemplary embodiments of a composite may also include other additives such as to enhance processing (e.g., lubricants, stabilizers, etc.) or composite performance (e.g., impact modifiers, high heat modifiers, coupling agents, UV resistance, foaming agents, mold and mildew inhibitors, oxidation inhibitors, coatings, etc.). For example, one embodiment of a composite may include:
1) Lubricants (e.g., paraffin wax, ethylene bis stearamide, calcium stearate, etc.) in an amount of 0 wt. % to about 10 wt. %, more preferably 0 wt. % to about 4 wt. %, and still more preferably 0 wt. % to about 2 wt. %, by weight of the CPC;
2) Stabilizers in an amount of 0 wt. % to about 5 wt. %, more preferably 0 wt. % to about 2 wt. %, and still more preferably 0 wt. % to about 1 wt. %, by weight of the CPC;
3) Impact Modifiers in an amount of 0 wt. % to about 16 wt. %, more preferably 0 wt. % to about 8 wt. %, and still more preferably 0 wt. % to about 4 wt. %, by weight of the CPC;
4) High heat modifiers, such as flame retardants, in an amount of 0 wt. % to about 30 wt. %, more preferably 0 wt. % to about 10 wt. %, and still more preferably 0 wt. % to about 5 wt. %, by weight of the CPC;
5) Coupling agents in an amount of 0 wt. % to about 4 wt. %, more preferably 0 wt. % to about 2 wt. %, by weight of the CPC;
6) UV Resistance modifier in an amount of 0 wt. % to about 15 wt. %, more preferably 0 wt. % to about 10 wt. %, by weight of the CPC; and/or
7) Foaming agents in an amount of 0 wt. % to 10 wt. % by weight of the CPC.

An example of a lubricant may include, but is not limited to, a lubricant package. A lubricant package may include ethylene bis stearamide, paraffin wax, calcium stearate, etc. In one embodiment, the lubricant package includes ethylene bis stearamide and calcium stearate and is included in an amount of 1 wt. % by weight of the CPC.

An example of a stabilizer may include, but is not limited to, a thermal stabilizer. Thermal stabilizers can also be employed, such as low volatility and hydrolysis-resistant organophosphites and hindered phenolic antioxidants can be employed. As above, the thermal stabilizer can be present in an amount from 0 wt. % to about 5 wt. % by weight of the CPC, from 0 wt. % to about 2 wt. % by weight of the CPC, or from 0 wt. % to about 1 wt. % by weight of the CPC.

A UV resistance modifier may include, for example, UV absorbers that act by shielding the composition from ultraviolet light, or hindered amine light stabilizers that act by scavenging the radical intermediates formed in the photo oxidation process. Generally, any UV stabilizer utilized in polyethylene or propylene siding can be used in the present invention. Again, generally from 0 wt. % to about 15 wt. % of the UV stabilizer can be employed in the present invention, typically 0 wt. % to 10 wt. % by weight of the CPC.

A high heat modifier may include, for example, a flame retardant. In one embodiment, aluminum trihydrate may be used in the CPC as a flame retardant. In one further embodiment, the CPC may contain 20 wt. % aluminum trihydrate. In another further embodiment, the CPC may contain 10 wt. % aluminum trihydrate. In yet another further embodiment, the CPC may contain 5 wt. % aluminum trihydrate. In some embodiments, talc may be used in the CPC as a flame retardant. In one further embodiment, the CPC may contain 30 wt. % talc. In another further embodiment, the CPC may contain 20 wt. % talc. In yet another further embodiment, the CPC may contain 10 wt. % talc. In another further embodiment, the CPC may contain 5 wt. % talc. In some embodiments, the CPC may contain both aluminum trihydrate and talc. In one such embodiment, the CPC may contain 5 wt. % aluminum trihydrate and 5 wt. % talc. In another such embodiment, the CPC may contain 20 wt. % aluminum trihydrate and 10 wt. % talc. In yet another such embodiment, the CPC may contain 10 wt. % aluminum trihydrate and 20 wt. % talc.

The CPC can also include pigments, dyes or other coloring agents typically used in plastics suitable for outdoor purposes.

In an exemplary embodiment, the materials of a CPC may be combined and formed in any suitable manner. For example, the materials may be combined as a dry blend, agglomerated, and/or compounded (e.g., into pellets). The combined materials may then be formed into final shape such as by extrusion or injection molding.

For example, to formulate the CPC of the present invention, the pulverized coal is initially heated to remove all moisture. This can be generally done by heating the coal to a temperature of 100° C. for an hour or more, until all surface moisture is removed.

Mixing equipment is selected based on the particular polymer. Generally, all of the components are blended together in a mixer and then either extruded or molded to form the composite material. With thermoplastic polymers, the polymer is blended with the coal and any necessary additives, such as a thermal stabilizer, UV stabilizer, pigments, coupling agents and flame retardants at elevated temperature and then formed into pellets. The pellets are formed into articles by molding or extrusion in order to form the final product.

As a result of the carbon source material and/or polymer, an exemplary embodiment of a composite may have improved moisture resistance characteristics; be less susceptible to thermal degradation relative to traditional cellulosic-filled composites; and/or have improved physical and manufacturing characteristics such as, but not limited to, strength, stiffness, impact resistance, and extrudability. In an exemplary embodiment, the improved properties may enable a CPC that is more suitable for structural or non-structural products such as for building, construction, infrastructure, transportation (e.g., automotive, airplanes, trucks, transportation structures, etc.), and furnishing applications. Examples of products that may be facilitated by an exemplary CPC include the following: wood replacement products such as, for example, decking, railing, siding, flooring, roofing, windows, and doors; and piping products such as, for example drainage. In one further embodiment, a wood replacement product is made using CPC including HDPE as a polymer. In another further embodiment, a piping product is made using a CPC including PVC as a polymer. Various other types of products may also be manufactured.

### Example 1

Materials

Table 1 shows the compositions of various carbon polymer composites (i.e., CPCs) that were tested and compared against wood polymer compositions (i.e., WPCs). The following compositions were primarily based on HDPE polymers and one of various carbon-based fillers. In addition to the listed amounts of the carbon-based filler, the samples tested further included 1 wt. % of a lubricant package, including blend of an aliphatic carboxylic acid salts and mono and diamides, and an amount of the HDPE polymer necessary to reach 100 wt. %. The mesh size values set out below for the fillers contain either one or two mesh sizes which correspond to the number of openings per square inch of mesh (i.e., the larger the mesh size number, the smaller the openings). Where only one mesh size is given, the filler particles used are smaller than the opening size. Where two mesh sizes are given, the filler particles used are smaller than the larger mesh openings and larger than the smaller mesh openings.

TABLE 1

| | | | Filler | |
|---|---|---|---|---|
| | | | loading level | |
| Polymer | Filler | Type | (wt. %) | Mesh Size |
| HDPE | Pittsburgh No. | Bituminous | 40, 50, 60, 70 | 120M |
| | 8 (P8) | | 50, 70 | 120-200M |
| | | | 50, 70 | 200-325M |
| | | | 50, 70 | 325-500M |
| | | | 50, 70 | 500M |
| | Reclaimed coal | | 50, 70 | 325M |
| | (Omnis) | | | |
| | Powder River | Sub- | 40, 50, 60, 70 | 120M |
| | Basin (PRB) | Bituminous | | |

These CPCs were compared to various WPCs, including Ohio University's WPC (OU WPC), Trex, Choicedek, TimberTech, Veranda, and FiberOn. The OU WPC is an HDPE-based composite containing approximately 60 wt. % filler, that filler including 50 wt. % wood flour and 10 wt. % talc, approximately 39 wt. % HDPE, and approximately 1 wt. % lubricant package by weight of the composite. The Trex WPC is a commercially available composite wood replacement product supplied by Trex Company, Inc. (commercially available under product name Trex Transcend). The Choicedek WPC is a commercially available composite wood replacement product supplied by Old Castle APG and Lowe's (commercially available under product name Foundations). The TimberTech WPC is a commercially available composite wood replacement product supplied by Azek Building Products (commercially available under product name Legacy). The Veranda WPC is a commercially available composite wood replacement product supplied by Fiberon and Home Depot (commercially available under product name Veranda). The Fiberon WPC is a commercially available composite wood replacement product supplied by Fiberon (commercially available under product name Good Life).

Methods

The HDPE-based CPCs were tested to determine properties including flexural strength (MPa) and flexural modulus (GPa). The flexural strength and flexural modulus of each sample was determined using the procedure outlined in ASTM D790. A bar of the CPC having rectangular cross section rests on two supports having a height H and separated by a distance L. At the halfway point between the two supports, a loading nose is used to apply a constantly increasing force until either rupture occurs or a maximum strain of 5.0% is reached. Afterward, the flexural strength is determined using the following equation:

$${σ}_{fM} = \frac{3 PL}{2 {bd}^{2}}$$

In the above formula, “P” represents the load at the point of maximum stress where stress does not increase with strain; “L” represents the length separating the two supports; “b” represents the width of the CPC bar perpendicular to both the length L and the height H; and “d” represents the deflection depth of the CPC bar at the maximum load. The flexural modulus is determined by calculating the slope of the stress/strain graph during flexural deformation.

Results

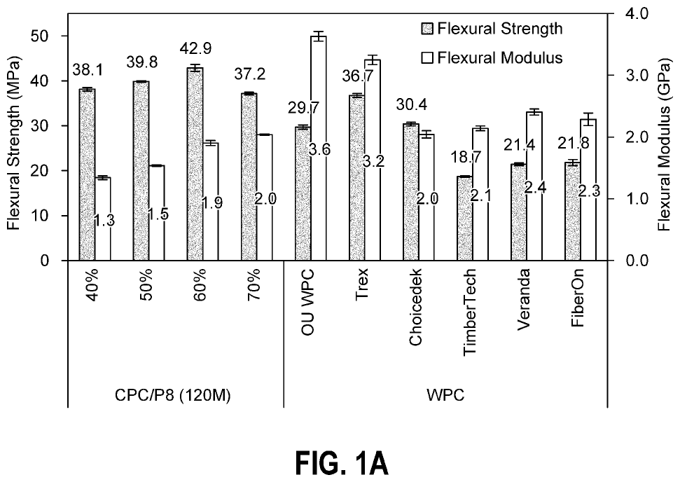

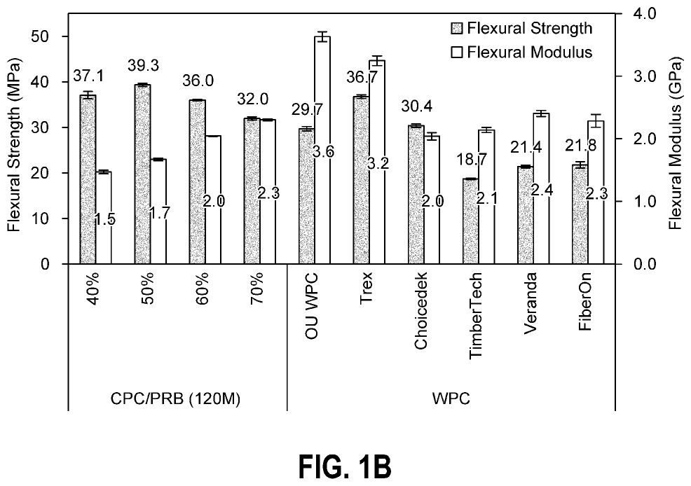

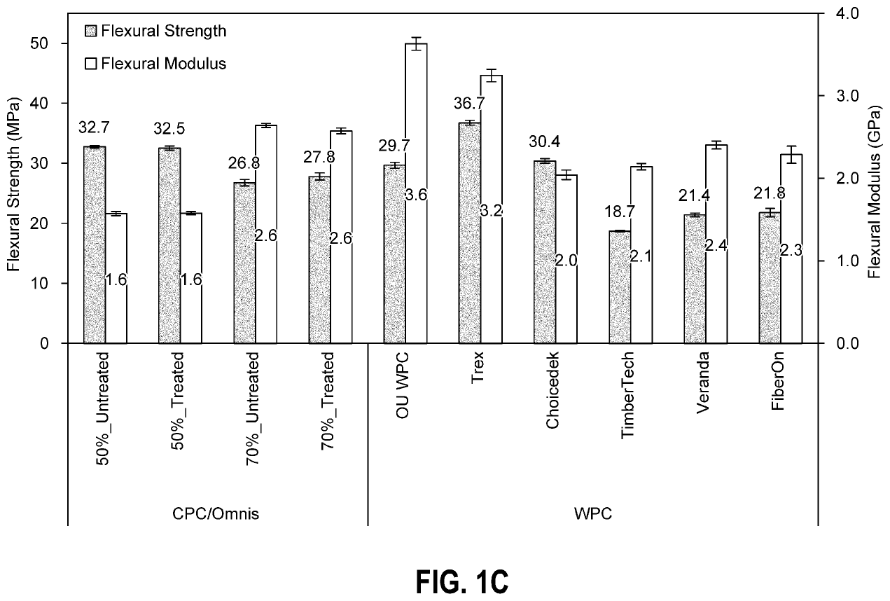

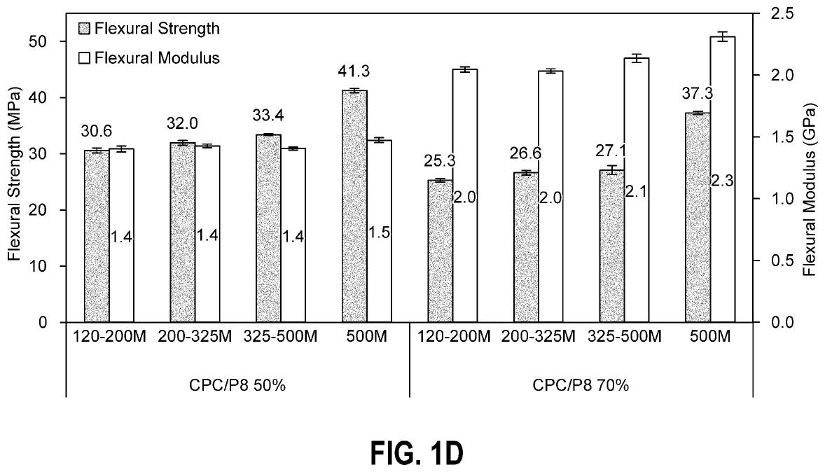

With reference to FIGS. 1A-1D, the flexural strengths and moduli for the HDPE-based CPCs were compared to various WPCs including OU WPC, Trex supplied by Trex Company, Inc., Choicedek supplied by Old Castle APG and Lowe's, TimberTech supplied by Azek Building Products, Veranda supplied by Fiberon and Home Depot, and FiberOn supplied by Fiberon. FIG. 1A compares HDPE-based CPCs including 120M mesh size Pittsburgh No. 8 (P8) coal filler at 40 wt. %, 50 wt. %, 60 wt. %, and 70 wt. % to the various WPCs. FIG. 1B compares HDPE-based CPCs including 120M mesh size Powder River Basin (PRB) coal filler at 40 wt. %, 50 wt. %, 60 wt. %, and 70 wt. % to the various WPCs. FIG. 1C compares HDPE-based CPCs including 325M mesh size Omnis reclaimed coal (Omnis) coal filler at 50 wt. % untreated, 50 wt. % treated, 70 wt. % untreated, and 70 wt. % treated to the various WPCs. Treated samples were subjected to 110° C. air for seven days. FIG. 1D compares HDPE-based CPCs including 50 wt. % P8 coal filler at various mesh sizes to CPCs containing 70 wt. % P8 coal fillers at various mesh sizes, those mesh sizes including 120-200M, 200-325M, 325-500M, and 500M.

With regard to flexural moduli, all CPCs demonstrated a correlation between increasing amounts of 120 mesh size coal filler and increasing flexural modulus with a maximum flexural modulus at 70 wt. %. With reference to FIG. 1D, there was also a correlation between increased mesh size (i.e., decreased particle size) and increased flexural modulus values for P8 coal at 50 wt. % and at 70 wt. %. However, as compared to the various WPCs, the HDPE-based CPCs exhibited maximum flexural modulus values (2.0-2.6 GPa) similar to some WPCs such as Choicedek (2.0 GPa) and Veranda (2.4 GPa) while other WPCs had higher flexural moduli such as OU WPC (3.6 GPa) and Trex (3.2 GPa).

With regard to the flexural strengths of the CPCs shown in FIGS. 1A-1D, increasing amounts of coal filler did not always increase flexural strength. For example, the 120M mesh size P8 coal CPC had maximum flexural strength at 60 wt. %, while CPCs containing 120M mesh size PRB or Omnis coal fillers had maximum flexural strengths at 50 wt. %. With reference to FIG. 1D, there was also a correlation between increased mesh size (i.e., decreased particle size) and increasing flexural strength for CPCs having P8 coal filler at both 50 wt. % and at 70 wt. %. When compared to the various WPCs, even the CPCs having the lowest flexural strengths had higher flexural strengths than half of the tested WPCs. Moreover, several of the flexural strengths from the tested CPCs exceeded the maximum flexural strength of all of the WPCs tested (Trex at 36.7 MPa).

These tests demonstrate both coal type and particle size of the carbon material influence composite properties. Specifically, higher rank coals which are a more hardened particle according to Hardgrove Grindability Index, such as bituminous coal compared to sub-bituminous coal, result in higher flexural strength from the material's ability to absorb more force before fracture. Smaller particle sizes increase flexural strength and provide better force distribution throughout the composite.

### Example 2

Materials

Table 2 shows the compositions of various CPCs that were tested and compared against a masterbatch formulation and a piping blend formulation. The following compositions were primarily based on a PVC polymer and one of several carbon-based fillers. The mesh size values set out below for the fillers contain either one or two mesh sizes which correspond to the number of openings per square inch of mesh (i.e., the larger the mesh size number, the smaller the openings). Where only one mesh size is given, the filler particles used are smaller than the opening size. Where two mesh sizes are given, the filler particles used are smaller than the larger mesh openings and larger than the smaller mesh openings. Where the mesh size is modified by a weight percentage (i.e., 325M (90 wt. %)), an amount of filler equal to that weight percentage (by weight of the filler particles only) are smaller than the mesh openings while another amount of filler necessary to reach 100 wt. % are larger than that mesh size.

TABLE 2

| | | | Filler | |
|---|---|---|---|---|
| | | | loading level | |
| Polymer | Filler | Type | (wt. %) | Mesh Size |
| PVC | Pittsburgh No. | Bituminous | 10, 20, 25, 30 | 120M |
| | 8 (P8) | | | 325-500M |
| | | | | 500M |
| | Keystone#325 | | 10, 20, 25, 30 | 325M |
| | Keystone#121 | Semi- | 10, 20, 25, 30 | 325M (90 |
| | | anthracite | | wt. %) |

These CPCs were compared to a masterbatch formulation and a piping blend formulation. The masterbatch formulation is a composite including the following components: a PVC resin in an amount greater than or equal to 60 wt. % and less than or equal to 80 wt. % by weight of the composite; a stabilizer in an amount greater than or equal to 1 wt. % and less than or equal to 3 wt. % by weight of the composite; a lubricant in an amount greater than or equal to 1 wt. % and less than or equal to 8 wt. % by weight of the composite; a process aid in an amount greater than or equal to 1 wt. % and less than or equal to 5 wt. % by weight of the composite; and an impact modifier in an amount greater than or equal to 2 wt. % and less than or equal to 8 wt. % by weight of the composite. The piping blend formulation is a composite including the following components: a PVC resin in an amount greater than or equal to 60 wt. % and less than or equal to 80 wt. % by weight of the composite; a stabilizer in an amount greater than or equal to 1 wt. % and less than or equal to 3 wt. % by weight of the composite; a lubricant in an amount greater than or equal to 1 wt. % and less than or equal to 8 wt. % by weight of the composite; a process aid in an amount greater than or equal to 1 wt. % and less than or equal to 5 wt. % by weight of the composite; an impact modifier in an amount greater than or equal to 2 wt. % and less than or equal to 8 wt. % by weight of the composite; and an organic filler in an amount greater than or equal to 5 wt. % and less than or equal to 40 wt. % by weight of the composite.

Methods

The PVC based carbon composites below were tested to determine properties including tensile strength (MPa), modulus of elasticity (MPa), and impact resistance (J/m). These values were compared to the class requirements for rigid PVC compounds given in ASTM-D1784.

The tensile strength and modulus of elasticity for each sample was determined using the procedure outlined in ASTM D638. A sample was placed in the grips of the testing machine which is designed to separate the grips and extend the sample at a constant rate. During this extension, the load-extension curve of the sample is graphed and any yield point or rupture point is noted. To determine the tensile strength, the maximum load sustained by the sample is divided by the original cross-sectional area of the sample. To determine the modulus of elasticity, the slope of the initial linear section is determined.

The impact resistance of each sample was determined using ASTM-D256. A sample was placed between two grips such that a standardized weight would fall from a known height to impact a region of the sample having a determined width and thickness. Then, the energy required to break a sample having a certain thickness is determined to calculate the impact resistance.

Results

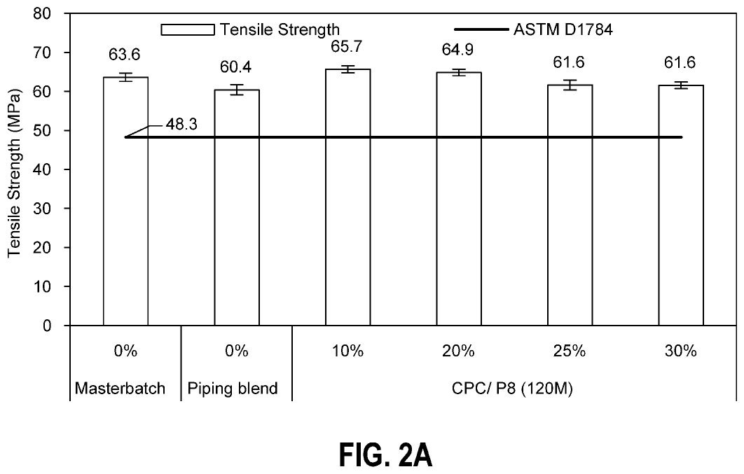

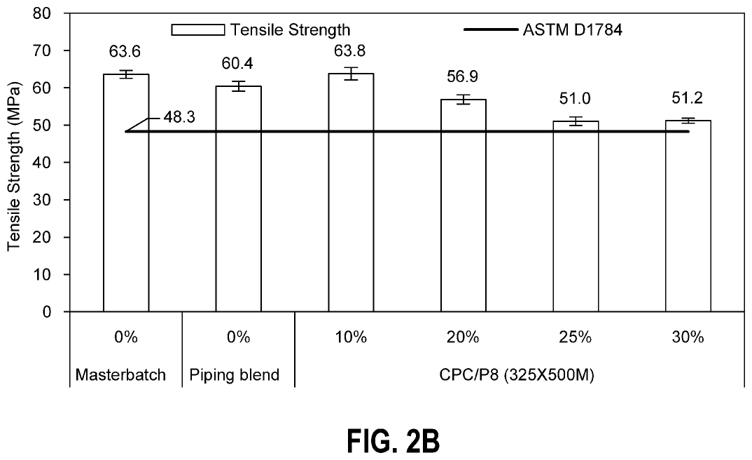

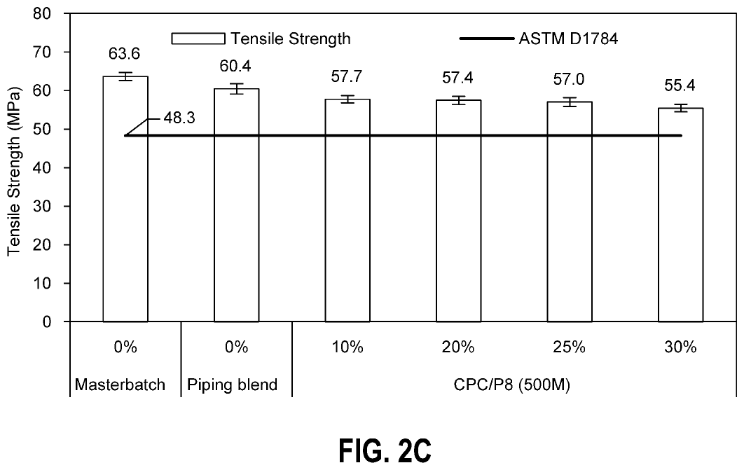

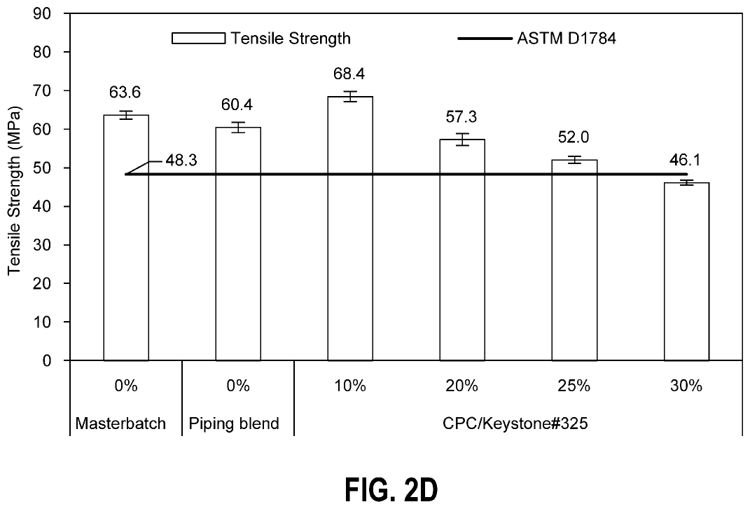

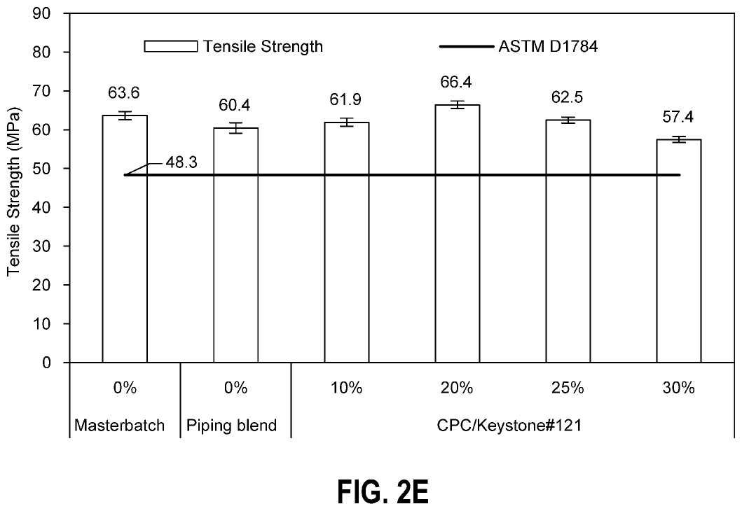

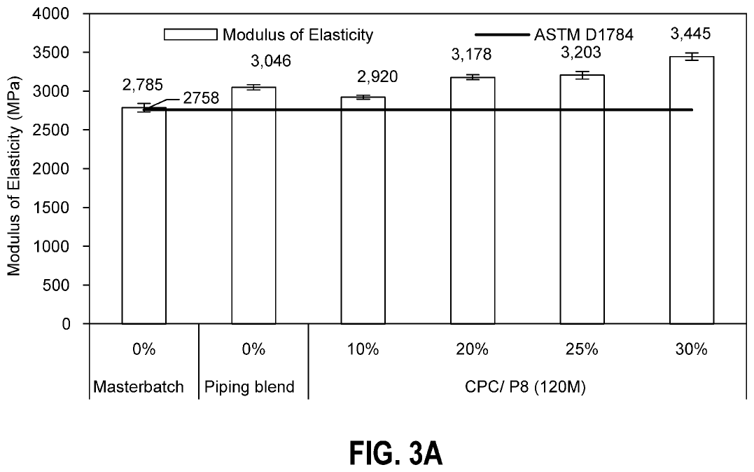

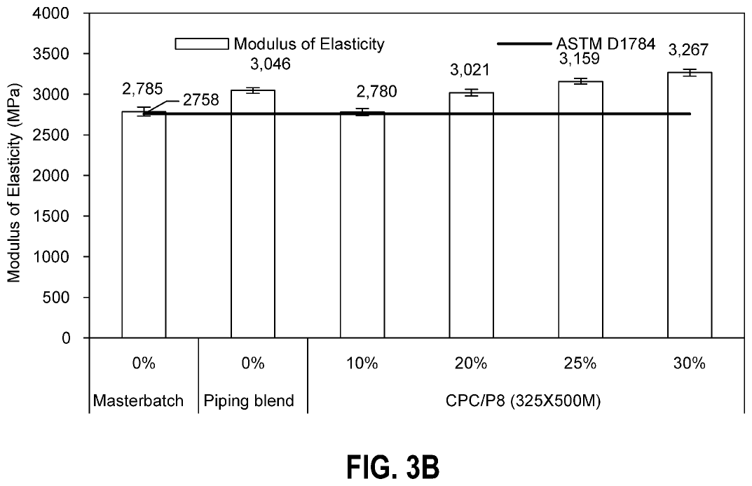

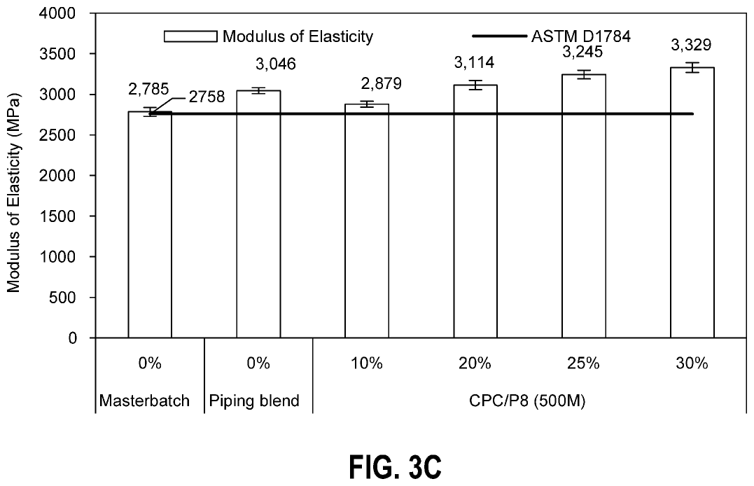

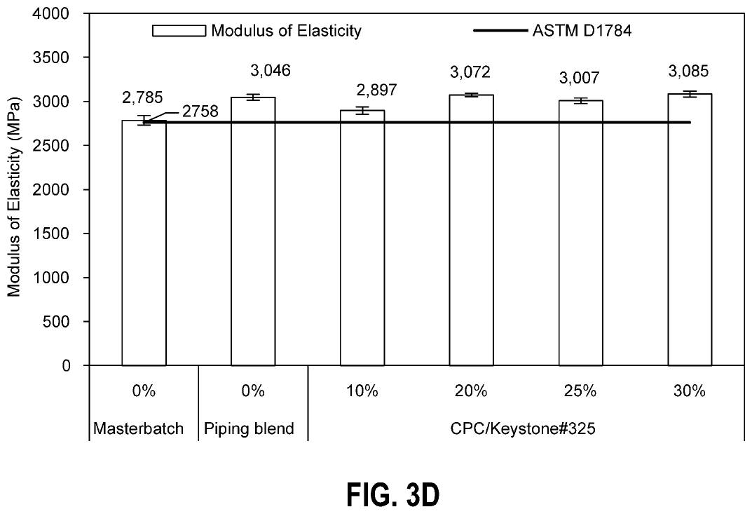

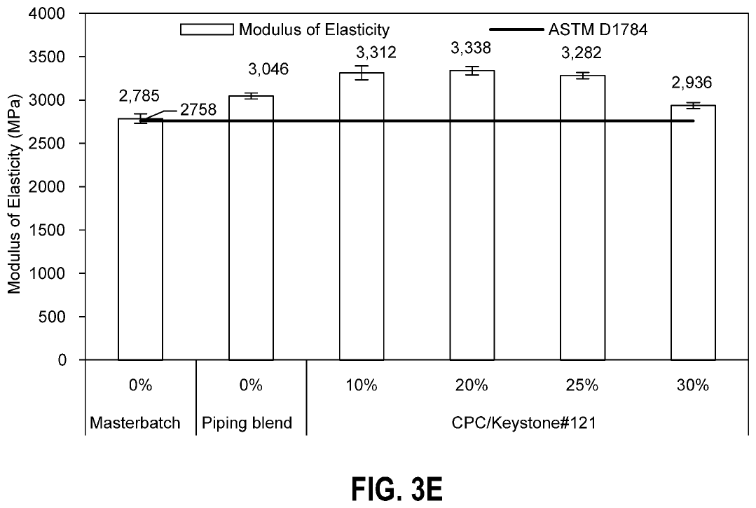

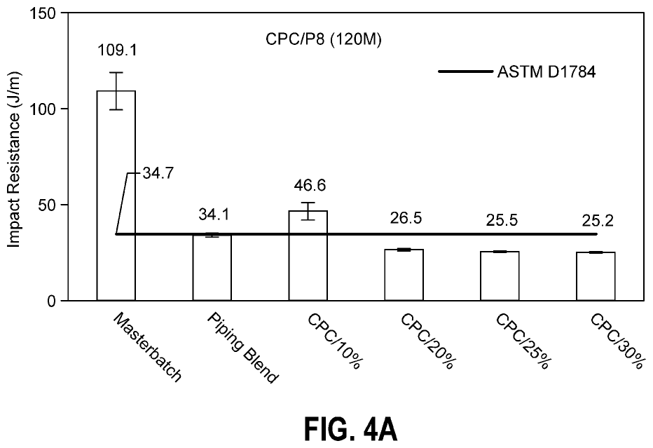

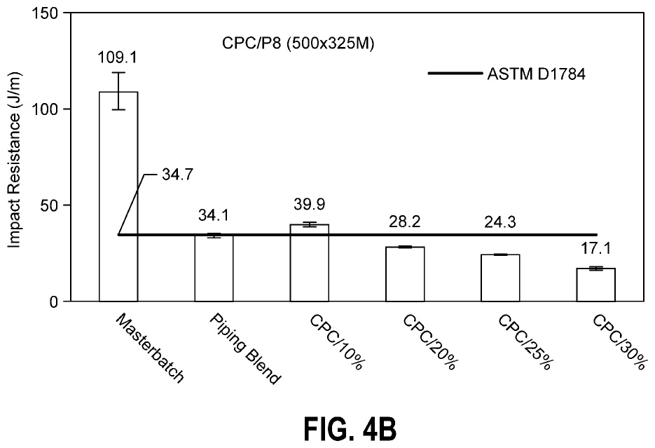

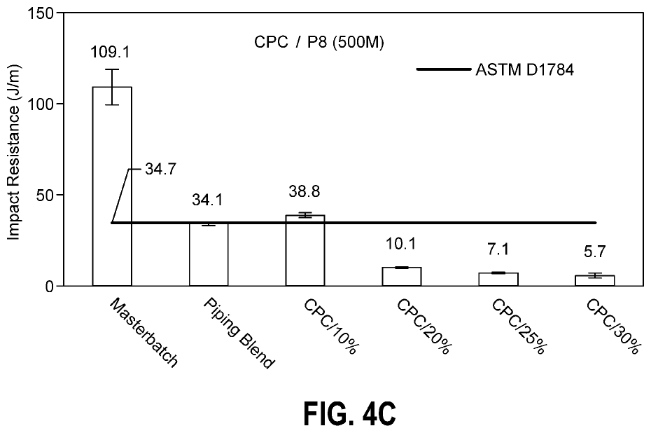

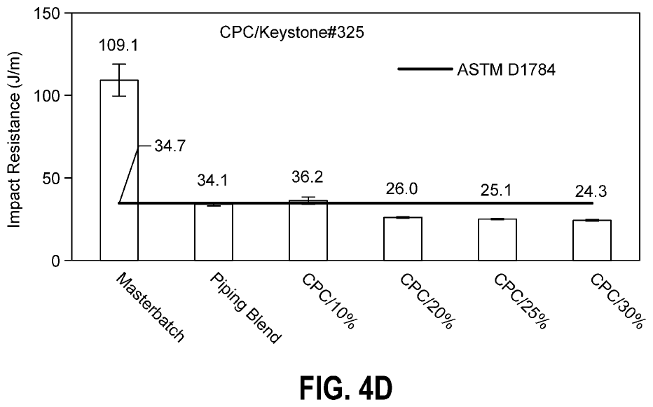

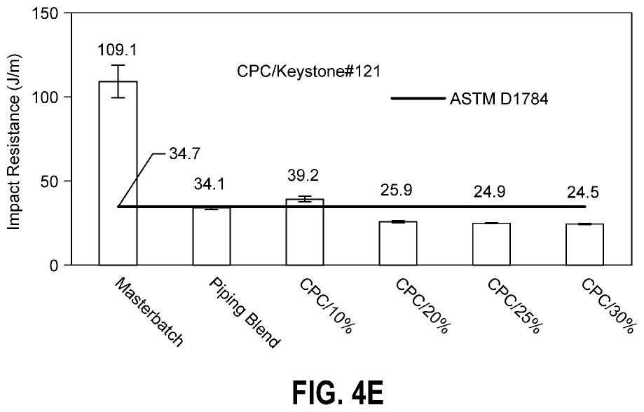

With reference to FIGS. 2A-2E, the tensile strengths of various PVC-based CPCs were compared to the masterbatch and the piping blend formulations. With reference to FIGS. 3A-3E, the moduli of elasticity of various PVC-based CPCs were compared to the masterbatch and the piping blend formulations. With reference to FIGS. 4A-4E, the impact resistances of various PVC-based CPCs were compared to the masterbatch and the piping blend formulations. FIGS. 2A, 3A, and 4A compare PVC-based CPCs including 120M mesh size Pittsburgh No. 8 (P8) coal filler at 10 wt. %, 20 wt. %, 25 wt. %, and 30 wt. % to the masterbatch and piping blend formulations. FIGS. 2B, 3B, and 4B compare PVC-based CPCs including 325-500M mesh size Pittsburgh No. 8 (P8) coal filler at 10 wt. %, 20 wt. %, 25 wt. %, and 30 wt. % to the masterbatch and piping blend formulations. FIGS. 2C, 3C, and 4C compare PVC-based CPCs including 500M mesh size Pittsburgh No. 8 (P8) coal filler at 10 wt. %, 20 wt. %, 25 wt. %, and 30 wt. % to the masterbatch and piping blend formulations. FIGS. 2D, 3D, and 4D compare PVC-based CPCs including 325M mesh size Keystone #325 coal filler at 10 wt. %, 20 wt. %, 25 wt. %, and 30 wt. % to the masterbatch and piping blend formulations. FIGS. 2E, 3E, and 4E compare PVC-based CPCs including 325M (90 wt. %) mesh size Keystone #121 coal filler at 10 wt. %, 20 wt. %, 25 wt. %, and 30 wt. % to the masterbatch and piping blend formulations.

With regard to tensile strength, CPCs including P8 filler and Keystone #325 demonstrated a correlation between increasing amounts coal filler and decreasing tensile strength with minor exceptions between 25 wt. % and 30 wt. % for CPCs including P8 filler at 120M and 325-500M mesh sizes. Keystone #121 instead showed an increase of tensile strength between 10 wt. % and 20 wt. % filler with a decreasing tensile strength at higher filler amounts. Moreover, when each type of filler was incorporated in an amount designed to maximize tensile strength, all fillers tested except for P8 with a 500M mesh size had a maximum tensile strength greater than both the masterbatch and the piping blend formulations. When classified using ASTM-D1784 Table 1, all samples tested at all filler amounts except for Keystone #325 at 30 wt. % meet the requirements of class 4 PVC compounds (i.e., exceeded 48.3 MPa).

With regard to the moduli of elasticity shown in FIGS. 3A-3E, increasing amounts of P8 coal filler was correlated with a greater modulus of elasticity across all mesh sizes tested. However, the same was not true for increasing amounts of Keystone #325 or #121 fillers past 20 wt. % amounts, with Keystone #121 demonstrating a correlation between increased filler amounts and decreased moduli of elasticity as filler is increased from 20 wt. % to 30 wt. %. Moreover, when each type of filler was incorporated in an amount designed to maximize modulus of elasticity, all fillers tested demonstrated moduli of elasticity greater than the masterbatch and piping blend. All samples tested had moduli of elasticity sufficient to be classified as class 5 PVC compounds using ASTM-D1784 (i.e., exceeded 2758 MPa).

With regard to impact resistance, increasing filler amounts was correlated with decreasing impact resistance across all fillers and mesh sizes tested, with the largest change in impact resistance between 10 wt. % and 20 wt. % across all samples. While the maximum impact resistances for each type of filler (10 wt. %) exceeded the impact resistance of the piping blend and was sufficient to be categorized as a class 2 PVC compound according to ASTM-D1784 (i.e., exceeded 34.7 J/m), none of the samples tested exceeded the impact resistance of the masterbatch formulation.

Contrary to behavior of impact modifiers, impact resistance of CPC materials increased with particle size, which could result in manufacturing cost advantages.

### Example 3

Materials

Table 3 shows the compositions of various CPCs that were tested and compared against various other wood replacement products. The following compositions were primarily based on HDPE polymers and P8 carbon-based fillers with 120M mesh size. In addition to the listed amounts of the HDPE and carbon-based filler, the samples tested further included 1 wt. % of a lubricant package including blend of an aliphatic carboxylic acid salts and mono and diamides. Some samples further included an amount of talc and/or an amount of aluminum trihydrate (ATH).

TABLE 3

| | | | | | Lubricant |
|---|---|---|---|---|---|
| | Coal Content | HDPE | Talc | ATH | Package |
| Formulation | (wt. %) | (wt. %) | (wt. %) | (wt. %) | (wt. %) |
| F1 | 70 | 29 | 0 | 0 | 1 |
| F2 | 60 | 29 | 5 | 5 | 1 |
| F3 | 60 | 29 | 10 | 0 | 1 |
| F4 | 60 | 29 | 0 | 10 | 1 |
| F5 | 40 | 29 | 10 | 20 | 1 |
| F6 | 40 | 29 | 20 | 10 | 1 |
| F7 | 40 | 29 | 30 | 0 | 1 |
| F8 | 50 | 29 | 0 | 20 | 1 |
| F9 | 40 | 59 | 0 | 0 | 1 |
| F10 | 60 | 39 | 0 | 0 | 1 |
| F11 | EP WPC | | | | |
| F12 | Pressure | | | | |
| | Treated lumber | | | | |
| F13 | Red Oak | | | | |

These CPCs were compared to various other wood products and wood replacement products, including Engineered Profiles WPC (EP WPC), pressure treated lumber, and red oak. The EP WPC is a wood based composite containing a blend of HDPE, wood filler and a lubricant package. The pressure treated lumber is a commercially available wood product material supplied by Lowe's (commercially available under product name Severe Weather). The red oak material is a commercially available wood product material supplied by Lowe's (commercially available under product name ReliaBilt).

Methods

The formulations listed above were tested to determine properties including total heat release (MJ/m²), peak heat release rate (HRR) (kW/m²), and total smoke release (m²/m²). The total heat release, peak HHR, and total smoke release of each sample was determined using the procedure outlined in ASTM-E1354. The mass and surface area of a sample was measured and the sample was placed in a calorimeter. The sample was subsequently ignited to achieve combustion and the above values were measured throughout the combustion of the sample.

Results

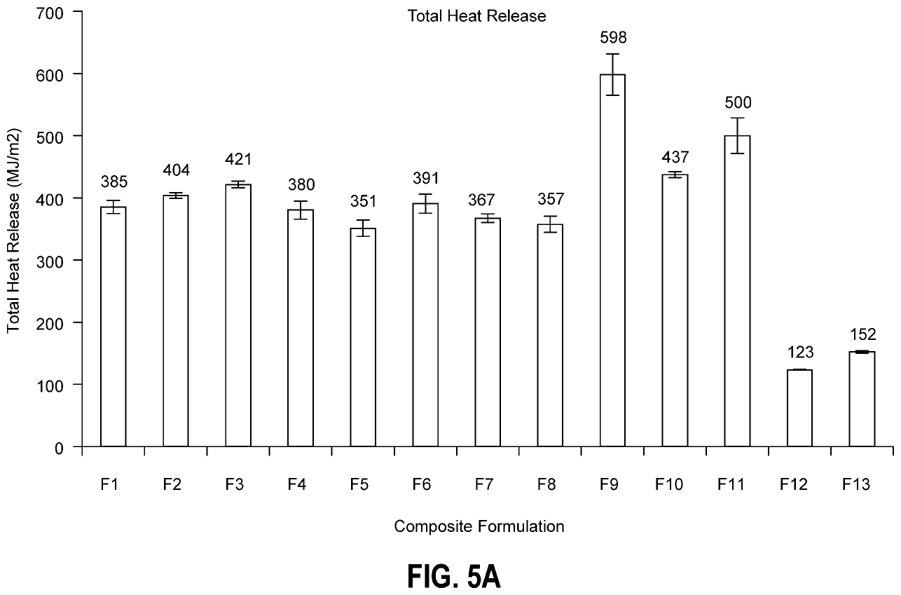

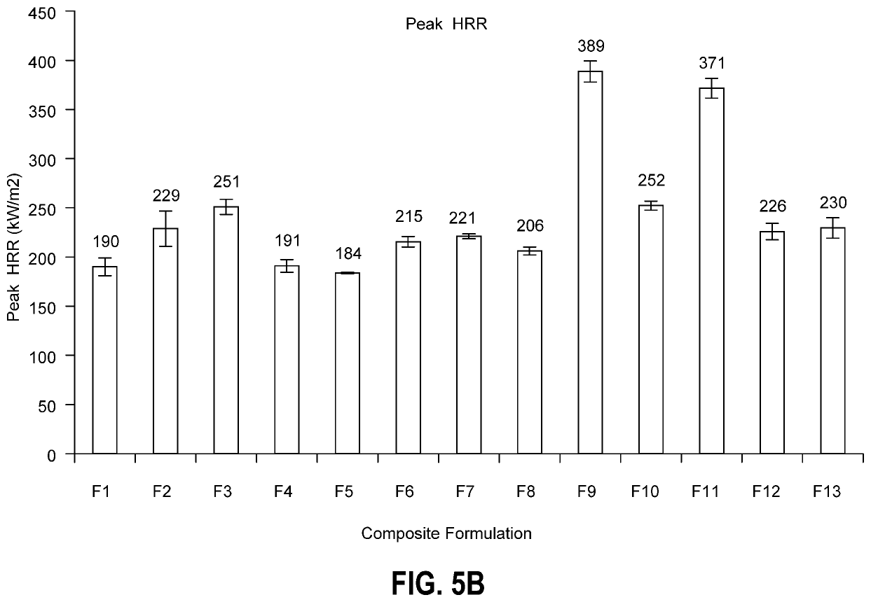

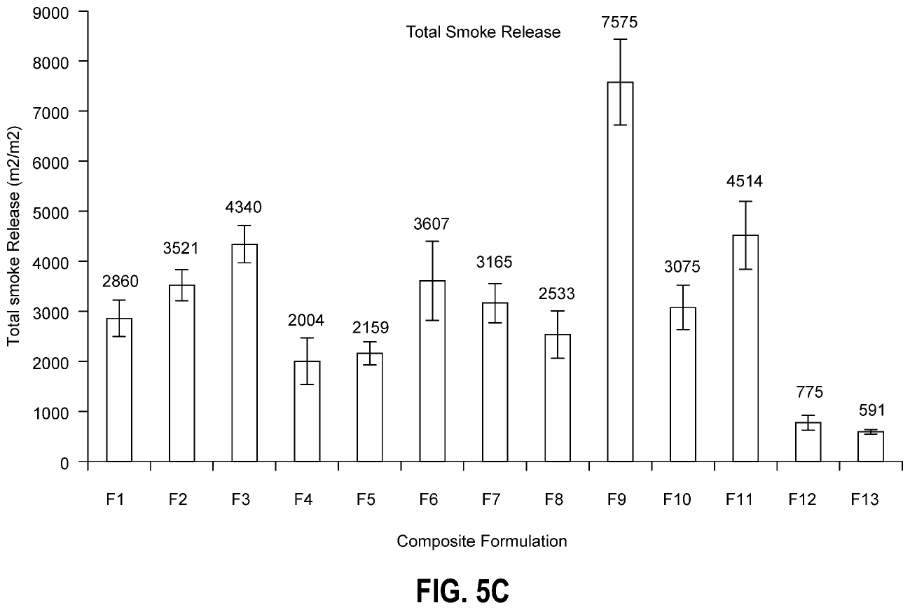

With reference to FIG. 5A, the total heat release for each of the tested samples are compared. When comparing CPCs not incorporating talc or ATH (F1, F10, and F9), there is a clear correlation between increasing amounts of HDPE and increased total heat release values. When comparing CPCs including 60 wt. % coal (F2, F3, F4, and F10) to determine the effects of incorporating 10 wt. % of talc and/or ATH, the sample without talc or ATH (F10) demonstrated higher total heat release values, followed by the talc sample (F3), the talc and ATH mixture (F2), and the ATH sample (F4). When comparing samples including 20-30 wt. % of talc and/or ATH (F5, F6, F7, and F8), there was a significant difference between the talc and ATH mixtures depending on whether more talc or ATH was used, with the talc heavy system (F6) having the highest total heat release and the ATH heavy system (F5) having the lowest total heat release. When these CPCs were compared against the various wood replacement products, only F9 demonstrated a higher total heat release than the EP WPC while all tested samples had higher total heat releases than pressure treated lumber or red oak.

With reference to FIG. 5B, the peak HRR for each of the tested samples are compared. When comparing CPCs not incorporating talc or ATH (F1, F10, and F9), there is a clear correlation between increasing amounts of HDPE and increased peak HRR values. When comparing CPCs including 60 wt. % coal (F2, F3, F4, and F10) to determine the effects of incorporating 10 wt. % total of talc and/or ATH, the sample without talc or ATH (F10) demonstrated nearly equivalent peak HRR to the 10 wt. % ATH system (F4), while the talc and ATH mixture (F2) and the 10 wt. % ATH sample (F3) demonstrated a correlation between increasing talc and increased peak HRR. When comparing samples including 20-30 wt. % of talc and/or ATH (F5, F6, F7, and F8), the same correlation of increasing talc (F5-F7) correlating with increasing peak HHR was found, with the light talc mixture (F5) demonstrating the lowest peak HRR of all CPCs tested. When these CPCs were compared against the various wood replacement products, only F9 demonstrated a higher peak HRR than the EP WPC while the other tested samples except for the 10 wt. % talc and ATH mixture (F2) and the 10 wt. % talc system (F3) had higher or comparable peak HHR values to the pressure treated lumber and red oak.

With reference to FIG. 5C, the total smoke release for each of the tested samples are compared. When comparing CPCs not incorporating talc or ATH (F1, F10, and F9), there is a clear correlation between increasing amounts of HDPE (i.e., decreasing amounts of coal) and increased total smoke release values with the 40 wt. % coal system (F9) having the greatest smoke release of all samples and wood replacement products. When comparing CPCs including 60 wt. % coal (F2, F3, F4, and F10) to determine the effects of incorporating 10 wt. % of talc and/or ATH, increasing amounts of talc (F10, F2, and F3) correlated with increased total smoke release while adding 10 wt. % of only ATH (F4) correlated with decreased total smoke release and the lowest smoke release of all CPCs tested. When comparing samples including 20-30 wt. % of talc and/or ATH (F5, F6, F7, and F8), the talc heavy system (F6) had the highest total smoke release, followed in order by the 30 wt. % talc system (F7), the 20 wt. % ATH system (F8), and the ATH heavy system (F5). When these CPCs were compared against the various wood replacement products, only F9 demonstrated a higher total smoke release than the EP WPC while all tested samples had higher total smoke releases than pressure treated lumber or red oak.

These tests indicate that that coal-based composite formulations possess better fire properties than existing WPC formulations possessing lower propensity for flammability and flame spread.

### Example 4

Materials

Table 4 shows the compositions of various CPCs that were tested and compared against various other wood replacement products. The following compositions were primarily based on HDPE polymers and one of several carbon-based fillers including Pittsburgh No. 8 (P8) with a 120M mesh size, Itman coal with a 120M mesh size, Keystone #325 having a 325M mesh size, and powder river basin (PRB) having a 120M mesh size. In addition to the listed amounts of the HDPE and carbon-based filler, the samples tested further included 1 wt. % of a lubricant package including blend of an aliphatic carboxylic acid salts and mono and diamides.

TABLE 4

| | | Filler | | Lubricant |
|---|---|---|---|---|
| | | Content | HDPE | Package |
| Formulation | Filler Type | (wt. %) | (wt. %) | (wt. %) |
| F1 | P8 | 70 | 29 | 1 |
| F2 | P8 | 50 | 49 | 1 |
| F3 | Itman | 70 | 29 | 1 |
| F4 | Itman | 50 | 49 | 1 |
| F5 | Keystone #325 | 50 | 49 | 1 |
| F6 | PRB | 70 | 29 | 1 |
| F7 | PRB | 50 | 49 | 1 |
| F8 | Commercial WPC | | | |
| (Trex) | | | | |
| F9 | Commercial WPC | | | |
| (Moisture Shield) | | | | |
| F10 | Commercial WPC | | | |
| (UltraDeck) | | | | |
| F11 | Commercial WPC | | | |
| (TimberTech) | | | | |
| F12 | Wood flour and | | | |
| (OU WPC) | Talc | | | |

These CPCs were compared to various other wood replacement products F8-F12, including Trex, Moisture Shield, Ultradeck, TimberTech, and OU WPC respectively. The Trex WPC is a commercially available composite wood replacement product supplied by Trex Company, Inc. (commercially available under product name Transcend). The Moisture Shield decking is a commercially available composite wood replacement product supplied by Lowes, Ace, and Carter Lumber (commercially available under product name Vision). The Ultradeck decking is a commercially available composite wood replacement product supplied by Midwest Manufacturing (commercially available under product name Inspire). The TimberTech WPC is a commercially available composite wood replacement product supplied by Azek Building Products (commercially available under product name Legacy). The OU WPC is an HDPE-based composite containing approximately 60 wt. % filler, that filler including 50 wt. % wood flour and 10 wt. % talc, approximately 39 wt. % HDPE, and approximately 1 wt. % lubricant package.

Methods

The formulations listed above were tested to determine properties including total heat release (MJ/m²), peak heat release rate (HRR) (kW/m²), and total smoke release (m²/m²). The total heat release, peak HHR, and total smoke release of each sample was determined using the procedure outlined in ASTM-E1354. The mass and surface area of a sample was measured and the sample was placed in a calorimeter. The sample was subsequently ignited to achieve combustion and the above values were measured throughout the combustion of the sample.

Results

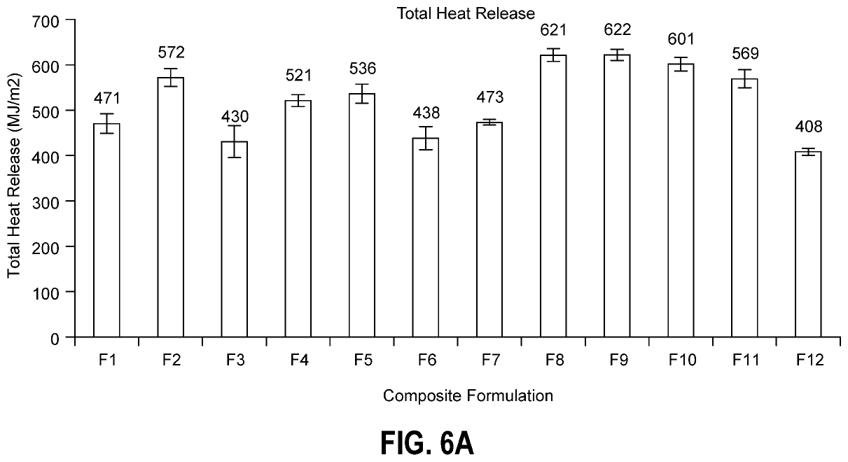

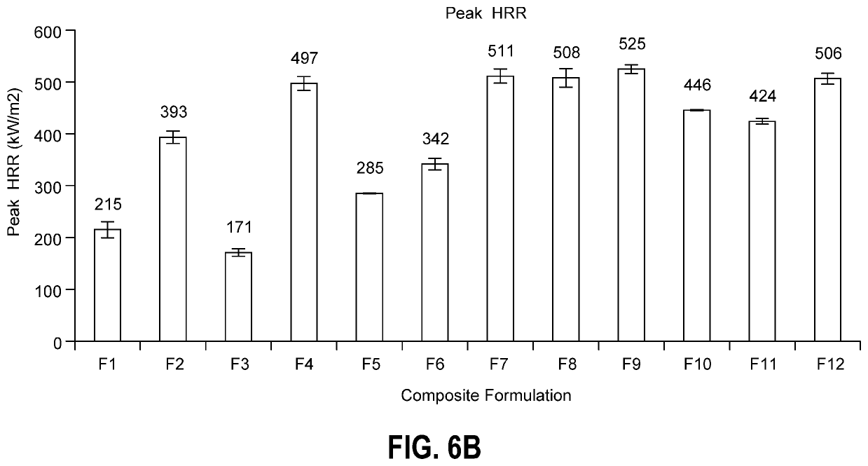

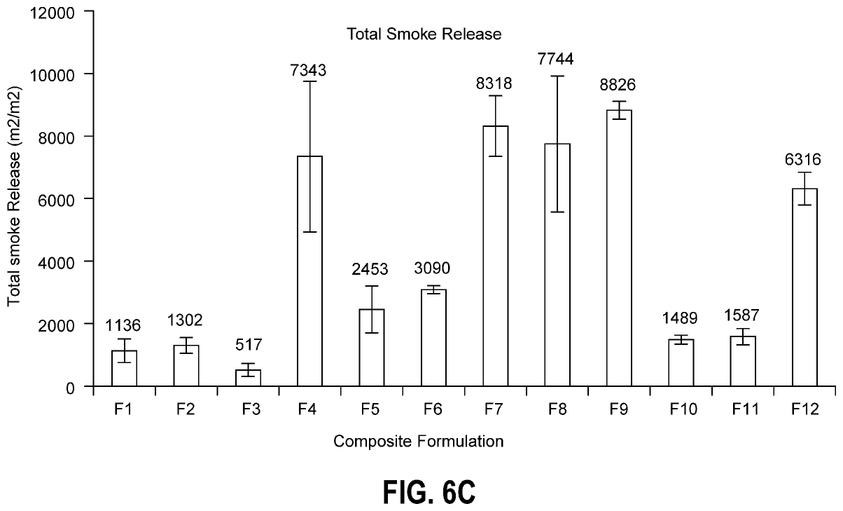

With reference to FIG. 6A, the total heat release for each of the tested samples are compared. When comparing CPCs having different amounts of the same filler (F1 and F2, F3 and F4, and F6 and F7) there is a clear correlation between increasing amounts of HDPE (i.e., decreasing amounts of filler) and increased total heat release values. When comparing CPCs including 70 wt. % of different types of coal filler (F1, F3, F6), the Itman sample (F3) was the CPC with the lowest total heat release, having a lower total heat release than PRB (F6), which in turn had less total heat release than P8 (F1). However, when comparing samples having 50 wt. % of different types of coal filler, the PRB sample (F7) had lower total heat release than Itman (F4), which in turn had lower total heat release than Keystone #325 (F5), which in turn had lower total heat release than P8 (F2) which was the highest total heat release of all CPCs tested. When these CPCs were compared against the various wood replacement products, all tested CPCs had higher total heat releases than OU WPC (F12). However, nearly all CPCs had lower total heat release values than the other wood replacement products (F8-F11) except for 50 wt. % P8 (F2) which was greater than the TimberTech sample (F11).

With reference to FIG. 6B, the peak HRR for each of the tested samples are compared. When comparing CPCs having different amounts of the same filler (F1 and F2, F3 and F4, and F6 and F7) there is a clear correlation between increasing amounts of HDPE (i.e., decreasing amounts of filler) and increased peak HRR values. When comparing CPCs including 70 wt. % of different types of coal filler (F1, F3, F6), the Itman sample (F3) was the CPC with the lowest peak HRR, having a lower peak HRR than P8 (F1), which in turn had a lower peak HRR than PRB (F6). However, when comparing samples having 50 wt. % of different types of coal filler, the Keystone #325 sample (F5) had a lower peak HRR than P8 (F2), which in turn had a lower peak HRR than Itman (F4) which in turn had a lower peak HRR than PRB (F7) which was the highest of all CPCs tested. When these CPCs were compared against the various wood replacement products, all tested CPCs had a lower peak HRR than the highest peak HRR for the WPCs, Moisture Shield (F9). In fact, nearly all CPCs had a lower peak HRR value than all tested WPCs (F8-F12), with the exceptions being 50 wt. % Itman (F4) and 50 wt. % PRB (F7).

With reference to FIG. 6C, the total smoke release for each of the tested samples are compared. When comparing CPCs having different amounts of the same filler (F1 and F2, F3 and F4, and F6 and F7) there is a clear correlation between increasing amounts of HDPE (i.e., decreasing amounts of filler) and increased total smoke release. In fact, both Itman (F3 and F4) and PRB (F6 and F7) demonstrated increases in total smoke release greater than an order of magnitude and greater than doubling respectively. When comparing CPCs including 70 wt. % of different types of coal filler (F1, F3, F6), the Itman sample (F3) was the CPC with the lowest total smoke release, having a lower total smoke release than P8 (F1), which in turn had less total smoke release than PRB (F6). However, when comparing samples having 50 wt. % of different types of coal filler (F2, F4, F5, and F7), the P8 sample (F2) had a lower total smoke release than the Keystone #325 sample (F5), which in turn had a lower total smoke release than Itman (F4) which in turn had a lower total smoke release than PRB (F7) which was the highest of all CPCs tested. When these CPCs were compared against the various wood replacement products, all tested CPCs had a lower total smoke release than the highest total smoke release for the WPCs, Moisture Shield (F9). However, while 50 wt. % samples of Itman (F4) and PRB (F7) exceeded the total smoke release of some WPCs including Trex (F8) and OU WPC (F12), all other CPCs had a lower total smoke release. In fact, both P8 CPCs (F1 and F2) and the 70 wt. % Itman (F3) had lower total smoke release values than all tested WPCs.

These tests indicate that coal provides beneficial properties which reduce heat and smoke release in comparison to WPC materials, potentially providing a more fire resistant and safer building material.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

1. A carbon polymer composite (CPC) comprising:
a polymer that accounts for greater than or equal to 10 wt. % and less than or equal to 90 wt. % by weight of the CPC; and
a carbon source material having a mesh size greater than or equal to 18M, wherein the carbon source material accounts for greater than or equal to 10 wt. % and less than or equal to 90 wt. % by weight of the CPC.

2. The CPC of claim 1, wherein the mesh size of the carbon source material is greater than or equal to 120M.

3. The CPC of claim 2, wherein the carbon source material has a second mesh size that is less than or equal to 500M.

4. The CPC of claim 2, wherein the mesh size of the carbon source material is greater than or equal to 500M.

5. The CPC of claim 4, wherein the mesh size of the carbon source material is greater than or equal to 4800M.

6. The CPC of claim 1, wherein the carbon source material comprises a plurality of particles having a shape such that each particle has a minimum Feret diameter, a maximum Feret diameter, and an aspect ratio equal to the maximum Feret diameter divided by the minimum Feret diameter, and wherein the plurality of particles has an average aspect ratio greater than or equal to 1.0.

7. The CPC of claim 6, wherein the plurality of particles has an average aspect ratio greater than or equal to 2.5.

8. The CPC of claim 7, wherein the plurality of particles has an average aspect ratio greater than or equal to 4.0.

9. The CPC of claim 8, wherein the plurality of particles has an average aspect ratio greater than or equal to 7.0.

10. The CPC of claim 1 further comprising a lubricant package that accounts for greater than 0 wt. % and less than or equal to 8 wt. % by weight of the CPC.

11. The CPC of claim 1, wherein the carbon source material comprises a material selected from the group consisting of anthracite coal, semianthracite coal, bituminous coal, sub-bituminous coal, lignite, waste coal, carbon black, coke, coke breeze, carbon foam, carbon foam dust, petroleum coke, biochar, and charcoal.

12. The CPC of claim 11, wherein the carbon containing material comprises coal which has been thermally oxidized via treatment with a gaseous oxidant.

13. The CPC of claim 11, wherein the carbon containing material comprises coal which has been oxidized via treatment with a liquid oxidizing agent.

14. The CPC of claim 1, wherein the carbon source material comprises a material selected from the group consisting of semi-anthracite coal, bituminous coal, and sub-bituminous coal.

15. The CPC of claim 14, wherein the polymer comprises PVC and accounts for greater than or equal to 10 wt. % and less than or equal to 90 wt. % by weight of the CPC, and wherein the carbon source material accounts for greater than or equal to 10 wt. % and less than or equal to 80 wt. % by weight of the CPC.

16. The CPC of claim 15, wherein the carbon containing material is selected from the group consisting of Pittsburgh No. 8 coal, Keystone #325 coal, and Keystone #121 coal.

17. A piping product comprising the CPC of claim 15.

18. The CPC as claimed in claim 14, wherein the polymer comprises HDPE and accounts for greater than or equal to 19 wt. % and less than or equal to 60 wt. % by weight of the CPC, and wherein the carbon source material accounts for greater than or equal to 10 wt. % and less than or equal to 79 wt. % by weight of the CPC.

19. The CPC of claim 18 further comprising a flame retardant that accounts for greater than or equal to 10 wt. % and less than or equal to 30 wt. % by weight of the CPC.

20. The CPC of claim 19 further comprising a flame retardant selected from the group consisting of talc, aluminum trihydrate, and a mixture of talc and aluminum trihydrate.

21. A wood replacement product comprising the CPC of claim 14.

22. The CPC of claim 1 further comprising an additive selected from the group consisting of a lubricant, a stabilizer, an impact modifier, a high heat modifier, a coupling agent, a UV resistance modifier, and a foaming agent.

23. The CPC of claim 22, wherein the additive is a foaming agent, and wherein the foaming agent accounts for less than or equal to 10 wt. % by weight of the CPC.

24. The CPC of claim 23 further comprising a non-carbon filler, wherein the non-carbon filler accounts for less than or equal to 30 wt. % by weight of the CPC, wherein the polymer comprises PVC, and wherein the carbon source material comprises coal.

25. The CPC of claim 1, wherein the carbon source material comprises reclaimed coal.

26. The CPC of claim 1 further comprising a non-carbon filler, wherein the non-carbon filler accounts for less than or equal to 30 wt. % by weight of the CPC.

27. The CPC of claim 26, wherein the carbon source material comprises reclaimed coal.

28. The CPC of claim 1, wherein the CPC further comprises a second carbon source material.
